(19) United States
(12) Patent Application Publication
(10) Pub. No.: US 2024/0169253 A1
(43) Pub. Date: May 23, 2024

(54) ACTIVE LEARNING IN MODEL TRAINING

(71) Applicant: International Business Machines Corporation, Arnonk, NY (US)

(72) Inventors: Dzung Tien Phan, Pleasantville, NY (US); Huozhi Zhou, Champaign, IL (US); Lam Minh Nguyen, Ossining, NY (US); Chandrasekhara K. Reddy, Kinnelon, NJ (US); Jayant R. Kalagnanam, Briarcliff Manor, NY (US)

(73) Assignee: International Business Machines Corporation, Armonk, NY (US)

(21) Appl. No.: 17/992,492

(22) Filed: Nov. 22, 2022

(51) Int. Cl. G06N 20/00; G06F 16/28

(52) U.S. Cl. CPC G06N 20/00; G06F 16/285

(57) ABSTRACT

Using a first dataset of labeled data, a model is trained by adjusting a feature extractor parameter, a classifier parameter, and a discriminator parameter of the model. Using the discriminator parameter and a parametric function of the feature extractor parameter, a plurality of samples of a dataset of unlabeled data is scored. A subset of the scored plurality of samples is selected for labeling. Responsive to receiving a label of each of the selected subset of the scored plurality of samples, the first dataset of labeled data is augmented with the selected subset of the scored plurality of samples and the label of each of the selected subset of the scored plurality of samples. Using the augmented dataset of labeled data, the model is retrained. The retraining comprises further adjusting the feature extractor parameter, the classifier parameter, and the discriminator parameter of the model.

### BACKGROUND

The present invention relates generally to a method, system, and computer program product for machine learning. More particularly, the present invention relates to a method, system, and computer program product for active learning in model training.

In machine learning, supervised learning methods train a model from labelled examples. In other words, using supervised learning a model learns a function that maps feature vectors (inputs) to labels (output), based on example input-output pairs. In active learning, an extension of supervised learning, new data points are iteratively selected for labelling, and the new labelled datapoints used to train a model. Active learning reduces the size of the training set needed to perform supervised learning, which is especially beneficial when the unlabeled data is abundant but the cost of labeling data is high. For example, when training a model to identify anomalies in medical images, a large number of images might be available, but each image might need to be examined by a human expert for labelling. Thus, reducing the number of labelled images required to train the model also reduces the cost and time needed to produce a trained model.

An imbalanced classification problem is an example of a classification problem where the distribution of examples across the known classes is biased or skewed, and thus imbalanced, with many more examples in one type or class than in another type or class. The distribution can vary from a slight bias to a severe imbalance where there is one example in the minority class for hundreds, thousands, or millions of examples in the majority class or classes. One example of an imbalanced classification problem is training a model to identify anomalies in medical images, because there are often many more examples of what is normal than what is not.

### SUMMARY

The illustrative embodiments provide a method, system, and computer program product. An embodiment includes a method that trains, using a first dataset of labeled data, a model, wherein the training comprises adjusting a feature extractor parameter of the model, a classifier parameter of the model, and a discriminator parameter of the model. An embodiment scores, using the discriminator parameter and a parametric function of the feature extractor parameter, a plurality of samples of a dataset of unlabeled data, the scoring resulting in a scored plurality of samples. An embodiment selects, for labeling, a subset of the scored plurality of samples, the selecting resulting in a selected subset of the scored plurality of samples. An embodiment augments, responsive to receiving a label of each of the selected subset of the scored plurality of samples, the first dataset of labeled data with the selected subset of the scored plurality of samples and the label of each of the selected subset of the scored plurality of samples, the augmenting resulting in an augmented dataset of labeled data. An embodiment retrains, using the augmented dataset of labeled data, the model, wherein the retraining comprises further adjusting the feature extractor parameter of the model, the classifier parameter of the model, and the discriminator parameter of the model.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for active learning in model training in accordance with an illustrative embodiment;

FIG. 3 depicts example pseudocode for implementing active learning in model training in accordance with an illustrative embodiment;

FIG. 3A depicts additional expression for use in implementing active learning in model training in accordance with an illustrative embodiment;

FIG. 4 depicts a flowchart of an example process for active learning in model training in accordance with an illustrative embodiment.

### DETAILED DESCRIPTION

The illustrative embodiments recognize that presently available active learning methods rely on an uncertainty criterion, a diversity criterion, or a combination. Using an uncertainty criterion selects, for labelling, the most uncertain samples from a pool of unlabeled data, using one or more uncertainty scoring functions. However, the queried data obtained by the uncertainty criterion is often unrepresentative of a distribution within the pool of unlabeled data, and as a result the model learns a biased objective. To overcome this sampling bias, other presently available active learning methods select data points to be queried according to a diversity criterion, by clustering numerical representations of data in the pool of unlabeled data and selecting one or more samples with numerical representations closest to the cluster centers for labelling. However, representative samples are typically computationally inefficient to identify using clustering.

Uncertainty and diversity criteria are useful in selecting the most informative data points to be queried for labelling. However, both assume there are an equal number of examples for each class. As a result, when used on an imbalanced dataset, the models do not perform sufficiently well, particularly for classifying data into the minority class. This is a problem because typically, the minority class is more important and therefore the problem is more sensitive to classification errors for the minority class than the majority class. Thus, the illustrative embodiments recognize that there is a need to improve the selection of data for which labelling is requested in active learning, particularly when training a model using an imbalanced dataset.

The illustrative embodiments recognize that the presently available tools or solutions do not address these needs or provide adequate solutions for these needs. The illustrative embodiments used to describe the invention generally address and solve the above-described problems and other problems related to active learning in model training.

An embodiment can be implemented as a software application. The application implementing an embodiment can be configured as a modification of an existing model training system, as a separate application that operates in conjunction with an existing model training system, a standalone application, or some combination thereof.

Particularly, some illustrative embodiments provide a method that uses a first dataset of labeled data to train a model, uses a parametric function of a feature extractor parameter and a discriminator parameter to score a plurality of samples of a dataset of unlabeled data, selects, for labeling, a subset of the scored plurality of samples, augments the first dataset of labeled data with the now-labeled selected subset of the scored plurality of samples, and uses the augmented dataset of labeled data to retrain the model.

An embodiment receives a plurality of learning parameters, or sets one or more of the learning parameters to default values. The learning parameters control training of a model using active learning. One learning parameter is a query budget (denoted by B), which is the total number of samples from a dataset that can be selected for labelling during the active learning process. Two other learning parameters are the number of model training cycles, or epochs, to be used in training the model (denoted by M) and a learning rate (denoted by η) of the model during training. An embodiment also receives a labeled dataset (denoted by L₀) and an unlabeled dataset (denoted by U₀). Each dataset includes data with which to train the model. The labeled dataset includes a label for each piece of data, so that when the data is input to the model, the model is expected to produce the label as output. In other words, the label represents a trained model's correct response to the data. The unlabeled dataset does not include data labels.

In a plurality of training epochs numbered from 1 to M, an embodiment uses a presently available technique to train the model using the labeled dataset. In particular, during each training epoch, an embodiment trains the model by updating three model parameters: a feature extractor parameter (denoted by θ^{e}), a classifier parameter (denoted by θ^{c}), and a discriminator parameter (denoted by θ^{d}). The feature extractor is used to extract the most informative features from the raw data, the classifier is used to predict the class of a given data point based on its features extracted by the feature extractor, and the discriminator is used to quantify how well a small subset of data points approximates the entire dataset. In particular, an embodiment computes updated θ^{e} using the expression θ^{e}−η(∂(R_{Lt}+Q(Lₜ, Uₜ))/∂θ^{e}). An embodiment computes updated θ^{c} using the expression θ^{c}−η(∂(R_{Lt})/∂θ^{c}). An embodiment computes updated θ^{d} using the expression θ^{d}+η(∂(Q(Lₜ, Uₜ)/∂θ^{d}). In each expression, t denotes a number of times unlabeled data has so far been selected, R_{Lt} denotes a prediction loss on currently labeled dataset Lₜ, Q(Lₜ, Uₜ)) denotes a quantization loss on currently labeled dataset Lₜ, and unlabeled dataset Uₜ, and ∂( ) denotes a gradient, the direction of greatest change of a scalar function. Prediction loss quantifies how well the model performs on the training dataset, and is related to the classification error rate of the model on the training dataset. If the model can classify the data from the training set with no errors, then the prediction loss is 0. Quantization loss quantifies how well the currently labeled dataset can approximate the entire dataset.

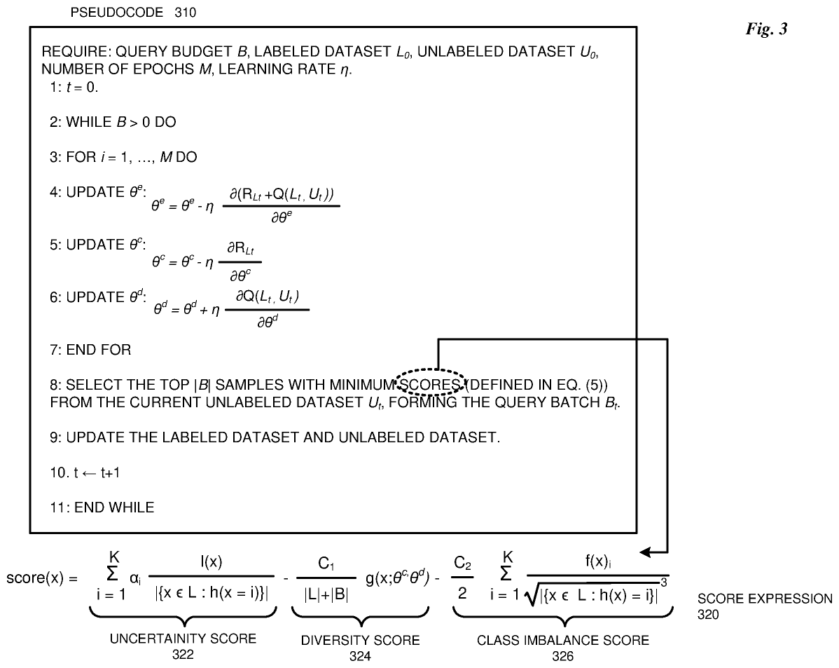

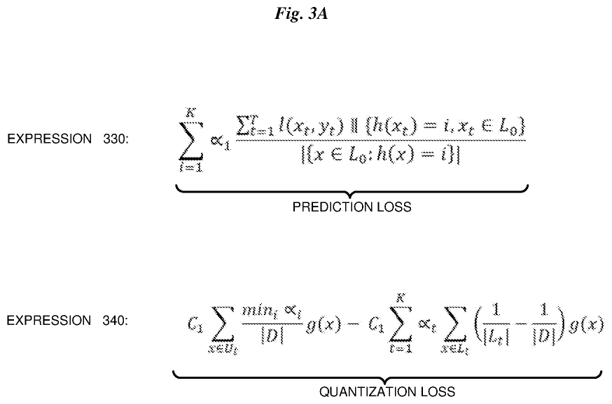

An embodiment computes a prediction loss R_{Lt} on currently labeled dataset Lₜ using expression 330 in FIG. 3A. In expression 330, l(denotes an error function with a value between 0 and 1, I(x) denotes the indicator function, ƒ(x)ᵢ is the i-th element of the K-tuple for the prediction function ƒ(x), h(x) is the labeling function. αᵢ is a weight of class-conditional risks, and |S| denotes the cardinality of the set S.

An embodiment computes a quantization loss Q(Lₜ, Uₜ) on currently labeled dataset Lₜ, and unlabeled dataset Uₜ using expression 340 in FIG. 3A. In expression 340, g(x) is a parametric critic function that quantifies how well the current labeled dataset approximates the entire (labeled and unlabeled) dataset. D is the dataset and C₁ is a positive parameter.

Once an embodiment has completed the M training epochs, an embodiment scores data in the unlabeled dataset. One embodiment scores all of the data in the unlabeled dataset, so that the next batch of data will be selected from as much data as possible. One embodiment computes an uncertainty score (denoted by sᵤ), a diversity score (denoted by s_{d}), and a class imbalance score (denoted by s_{c}), and combines them using the expression score=sᵤ−s_{d}−s_{c}. Combining the uncertainty, diversity, and class imbalance score in one expression implements a trade-off among uncertainty, diversity and class imbalance. Other score combinations combining the uncertainty, diversity, and class imbalance score into one overall score are also possible and contemplated within the scope of the illustrative embodiments.

An embodiment, the uncertainty score as a weighted sum of all i, in which each element in the sum is an upper bound of the loss incurred on an unlabeled data point divided by the number of data points belonging to a particular class of data points i. An embodiment computes a diversity score using the expression (C₁/(|L|+|B|))*g(x; θ^{e}, θ^{d}), in which C₁ denotes a data selection parameter, |L| denotes the number of data points in the current labeled dataset, |B| denotes the number of data points to be queried in the next iteration, and g(x; θ^{e}, θ^{d}) is a parametric critic function that quantifies how well the current labeled dataset approximates the entire (labeled and unlabeled) dataset. An embodiment computes an imbalance score as C₂/2, multiplied by the sum of f(x)ᵢ divided by the cube root of the number of data points belonging to a particular class i, for all values of i from 1 to K. C₂ denotes a data selection parameter and f(x)ᵢ denotes a function the model is being trained to perform. One embodiment receives settings for C₁ and C₂, while another embodiment uses default settings for C₁ and C₂.

An embodiment selects, for labeling, a subset of the scored plurality of samples from the unlabeled dataset. One embodiment selects, as the subset to be labeled, the |B| samples having the lowest scores (the lowest score is considered the best score) from the unlabeled dataset. An embodiment also subtracts the number of samples in the subset to be labeled from the query budget B. If the query budget is greater than zero, there are samples remaining in the query budget, and thus an embodiment sends the selected samples to be labeled. The labeling is performed by an automated labeling service, a human expert, or another presently available technique.

An embodiment receives the now-labeled selected samples and adds them to the set of labeled samples. An embodiment repeats the model training process, including use of the newly-labeled samples, until the query budget B has been exhausted, all the available data has been labeled and used to train the model, the model meets a model performance criterion (e.g., the model classifies more than a threshold percentage of samples correctly, or the model classifies more than a threshold percentage of a particular class of samples correctly), or another model training ending condition is satisfied. Once a model training ending condition is satisfied, an embodiment uses the now-trained model to perform the function for which the model was trained. For example, if the model was being trained to identify and classify anomalies in medical images, an embodiment uses the now-trained model to identify and classify anomalies in new medical images that were not part of the original training data.

The manner of active learning in model training described herein is unavailable in the presently available methods in the technological field of endeavor pertaining to machine learning. A method of an embodiment described herein, when implemented to execute on a device or data processing system, comprises substantial advancement of the functionality of that device or data processing system in using a first dataset of labeled data to train a model, using a parametric function of a feature extractor parameter and a discriminator parameter to score a plurality of samples of a dataset of unlabeled data, selecting, for labeling, a subset of the scored plurality of samples, augmenting the first dataset of labeled data with the now-labeled selected subset of the scored plurality of samples, and using the augmented dataset of labeled data to retrain the model.

The illustrative embodiments are described with respect to certain types of models, learning parameters, model parameters, scores, error functions, labeling functions parametric critic functions, classification functions, data samples, thresholds, validations, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

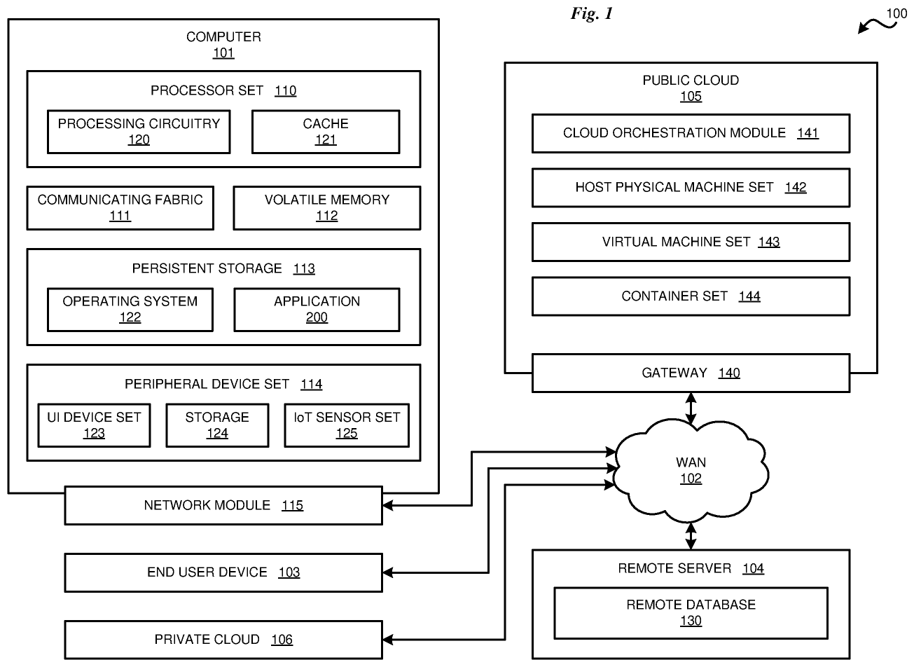

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements an active learning embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

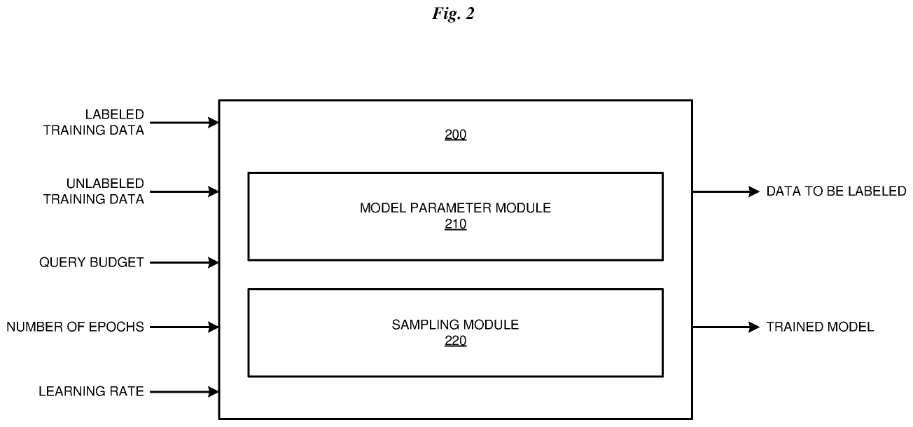

With reference to FIG. 2, this figure depicts a block diagram of an example configuration for active learning in model training in accordance with an illustrative embodiment. Application 200 is the same as application 200 in FIG. 1.

Application 200 receives a plurality of learning parameters, or sets one or more of the learning parameters to default values. The learning parameters control training of a model using active learning. One learning parameter is a query budget (denoted by B), which is the total number of samples from a dataset that can be selected for labelling during the active learning process. Two other learning parameters are the number of model training cycles, or epochs, to be used in training the model (denoted by M) and a learning rate (denoted by η) of the model during training. An embodiment also receives a labeled dataset (denoted by L₀) and an unlabeled dataset (denoted by U₀). Each dataset includes data with which to train the model. The labeled dataset includes a label for each piece of data, so that when the data is input to the model, the model is expected to produce the label as output. In other words, the label represents a trained model's correct response to the data. The unlabeled dataset does not include data labels.

In a plurality of training epochs numbered from 1 to M, application 200 uses a presently available technique to train the model using the labeled dataset. In particular, during each training epoch, model parameter module 210 trains the model by updating three model parameters: a feature extractor parameter (denoted by θ^{e}), a classifier parameter (denoted by θ^{c}), and a discriminator parameter (denoted by θ^{d}). In particular, module 210 computes updated θ^{e} using the expression θ^{e}−η(∂(R_{Lt}+Q(Lₜ, Uₜ))/∂θ^{e}). Module 210 computes updated θ^{c} using the expression θ^{c}−η(∂(R_{Lt})/∂θ^{c}). Module 210 computes updated θ^{d} using the expression θ^{d}+η(∂(Q(Lₜ, Uₜ)/∂θ^{d}). In each expression, t denotes a number of times unlabeled data has so far been selected, R_{Lt} denotes a prediction loss on currently labeled dataset Lₜ, Q(Lₜ, Uₜ)) denotes a quantization loss on currently labeled dataset Lₜ, and unlabeled dataset Uₜ, and ∂( ) denotes a gradient.

Once module 210 has completed the M training epochs, sampling module 220 scores data in the unlabeled dataset. One implementation of module 220 scores all of the data in the unlabeled dataset. One implementation of module 220 computes an uncertainty score (denoted by sᵤ), a diversity score (denoted by s_{d}), and a class imbalance score (denoted by s_{c}), and combines them using the expression score=sᵤ−s_{d}−s_{c}. Combining the uncertainty, diversity, and class imbalance score in one expression implements a trade-off among uncertainty, diversity and class imbalance.

Module 220 computes the uncertainty score as a weighted sum of all i, in which each element in the sum is an upper bound of the loss incurred on an unlabeled data point divided by the number of data points belonging to a particular class of data points i. Module 220 computes a diversity score using the expression (C₁/(|L|+|B|))*g(x; θ^{e}, θ^{d}), in which C₁ denotes a data selection parameter, |L| denotes the number of data points in the current labeled dataset, |B| denotes the number of data points to be queried in the next iteration, and g(x; θ^{e}, θ^{d}) is a parametric critic function that quantifies how well the current labeled dataset approximates the entire (labeled and unlabeled) dataset. Module 220 computes an imbalance score as C₂/2, multiplied by the sum of f(x)ᵢ divided by the cube root of the number of data points belonging to a particular class i, for all values of i from 1 to K. C₂ denotes a data selection parameter and f(x)ᵢ denotes the function the model is being trained to perform. One implementation of module 220 receives settings for C₁ and C₂, while another implementation of module 220 uses default settings for C₁ and C₂.

Module 220 selects, for labeling, a subset of the scored plurality of samples from the unlabeled dataset. One implementation of module 220 selects, as the subset to be labeled, the |B| samples having the lowest scores (the lowest score is considered the best score) from the unlabeled dataset. Module 220 also subtracts the number of samples in the subset to be labeled from the query budget B. If the query budget is greater than zero, there are samples remaining in the query budget, and thus module 220 sends the selected samples to be labeled. The labeling is performed by an automated labeling service, a human expert, or another presently available technique.

Application 300 receives the now-labeled selected samples and adds them to the set of labeled samples. Application 300 repeats the model training process, including use of the newly-labeled samples, until the query budget B has been exhausted, all the available data has been labeled and used to train the model, the model meets a model performance criterion (e.g., the model classifies more than a threshold percentage of samples correctly, or the model classifies more than a threshold percentage of a particular class of samples correctly), or another model training ending condition is satisfied. Once a model training ending condition is satisfied, application 300 uses the now-trained model to perform the function for which the model was trained. For example, if the model was being trained to identify and classify anomalies in medical images, application 300 uses the now-trained model to identify and classify anomalies in new medical images that were not part of the original training data.

With reference to FIG. 3, this figure depicts example pseudocode for implementing active learning in model training in accordance with an illustrative embodiment. The pseudocode can be executed using application 200 in FIG. 2.

In particular, FIG. 3 depicts pseudocode 310. In line 1, variable t is initialized to zero. Lines 2-11 include code that is executed while query budget B is greater than zero. Lines 3-7 include code that iterates over a plurality of training epochs numbered from 1 to M, with i denoting the current training epoch. In each training epoch i, pseudocode 310 updates three model parameters: a feature extractor parameter (denoted by θ^{e}), a classifier parameter (denoted by θ^{c}), and a discriminator parameter (denoted by θ^{d}), using the depicted expressions. In each expression, R_{Lt} denotes a prediction loss on currently labeled dataset Lₜ, Q(Lₜ, Uₜ)) denotes a quantization loss on currently labeled dataset Lₜ, and unlabeled dataset Uₜ, and ( ) denotes a function.

Once pseudocode 310 has completed the M training epochs, in line 8 pseudocode 310 uses score expression 320 to score data in the unlabeled dataset. Score expression 320 computes uncertainty score 322, diversity score 324, and class imbalance score 326 and combines them. Within uncertainty score 322, 1(x) denotes an upper bound of the loss incurred on an unlabeled data point, and the denominator denotes the number of data points belonging to a particular class i. Within diversity score 324, C₁ denotes a data selection parameter, ILI denotes the number of data points in the current labeled dataset, |B| denotes the number of data points to be queried in the next iteration, and g(x; θ^{e}, θ^{d}) is a parametric critic function that quantifies how well the current labeled dataset approximates the entire (labeled and unlabeled) dataset. Within class imbalance score 326, C₂ denotes a data selection parameter, f(x)ᵢ denotes the function the model is being trained to perform, and the denominator denotes the number of data points belonging to a particular class i. Line 8 also selects, as the subset to be labeled, the |B| samples having the lowest scores (the lowest score is considered the best score) from the unlabeled dataset.

In line 9, pseudocode 310 subtracts the number of samples in the subset to be labeled from the query budget B and adds the now-labeled selected samples to the set of labeled samples. In line 10, pseudocode 310 increments t, and in line 11 pseudocode 310 returns to line 3 if query budget B is still greater than zero.

With reference to FIG. 3A, this figure depicts additional expression for use in implementing active learning in model training in accordance with an illustrative embodiment. The expressions can be computed using application 200 in FIG. 2. In particular, expression 330 expresses computation of a prediction loss, and expression 340 expresses computation of a quantization loss.

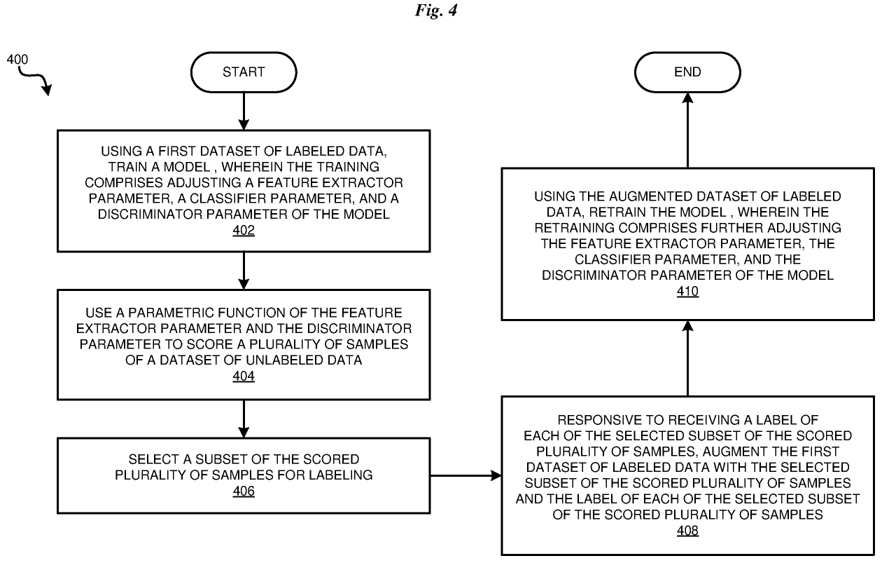

With reference to FIG. 4, this figure depicts a flowchart of an example process for active learning in model training in accordance with an illustrative embodiment. Process 400 can be implemented in application 200 in FIG. 2.

In block 402, the application, using a first dataset of labeled data, trains a model, wherein the training comprises adjusting a feature extractor parameter, a classifier parameter, and a discriminator parameter of the model. In block 404, the application uses a parametric function of the feature extractor parameter and the discriminator parameter to score a plurality of samples of a dataset of unlabeled data. In block 406, the application selects a subset of the scored plurality of samples for labeling. In block 408, the application, responsive to receiving a label of each of the selected subset of the scored plurality of samples, augments the first dataset of labeled data with the selected subset of the scored plurality of samples and the label of each of the selected subset of the scored plurality of samples. In block 410, the application, using the augmented dataset of labeled data, retrains the model, wherein the retraining comprises further adjusting the feature extractor parameter, the classifier parameter, and the discriminator parameter of the model. Then the application ends.

Thus, a computer implemented method, system or apparatus, and computer program product are provided in the illustrative embodiments for active learning in model training and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
training, using a first dataset of labeled data, a model, wherein the training comprises adjusting a feature extractor parameter of the model, a classifier parameter of the model, and a discriminator parameter of the model;
scoring, using the discriminator parameter and a parametric function of the feature extractor parameter, a plurality of samples of a dataset of unlabeled data, the scoring resulting in a scored plurality of samples;
selecting, for labeling, a subset of the scored plurality of samples, the selecting resulting in a selected subset of the scored plurality of samples;
augmenting, responsive to receiving a label of each of the selected subset of the scored plurality of samples, the first dataset of labeled data with the selected subset of the scored plurality of samples and the label of each of the selected subset of the scored plurality of samples, the augmenting resulting in an augmented dataset of labeled data; and
retraining, using the augmented dataset of labeled data, the model, wherein the retraining comprises further adjusting the feature extractor parameter of the model, the classifier parameter of the model, and the discriminator parameter of the model.

2. The computer-implemented method of claim 1, wherein the discriminator parameter of the model is adjusted using a quantization loss of the model.

3. The computer-implemented method of claim 2, wherein scoring the plurality of samples of a dataset of unlabeled data comprises combining an uncertainty score, a diversity score and a class imbalance score of a sample in the plurality of samples.

4. The computer-implemented method of claim 3, wherein the uncertainty score is computed using a weighted sum, each addend in the weighted sum comprising an upper bound of losses incurred on an unlabeled data point divided by the number of data points belonging to a particular class of data points.

5. The computer-implemented method of claim 3, wherein the diversity score is computed using a number of data points in the first dataset of labeled data, a number of data points in the selected subset of the scored plurality of samples, and the parametric function, the parametric function quantifying how well the first dataset of labeled data represents a combined dataset, the combined dataset comprising the first dataset of labeled data and the dataset of unlabeled data.

6. The computer-implemented method of claim 3, wherein the class imbalance score is computed using a weighted sum, each addend in the weighted sum comprising a result of performing the model divided by the cube root of the number of data points belonging to a particular class of data points.

7. The computer-implemented method of claim 1, further comprising:
subtracting, from a query budget, a number of samples in the selected subset of the scored plurality of samples.

8. The computer-implemented method of claim 7, further comprising:
causing, responsive to determining that the query budget is greater than zero, labeling of the selected subset of the scored plurality of samples.

9. A computer program product comprising one or more computer readable storage medium, and program instructions collectively stored on the one or more computer readable storage medium, the program instructions executable by a processor to cause the processor to perform operations comprising:
training, using a first dataset of labeled data, a model, wherein the training comprises adjusting a feature extractor parameter of the model, a classifier parameter of the model, and a discriminator parameter of the model;
scoring, using the discriminator parameter and a parametric function of the feature extractor parameter, a plurality of samples of a dataset of unlabeled data, the scoring resulting in a scored plurality of samples;
selecting, for labeling, a subset of the scored plurality of samples, the selecting resulting in a selected subset of the scored plurality of samples;
augmenting, responsive to receiving a label of each of the selected subset of the scored plurality of samples, the first dataset of labeled data with the selected subset of the scored plurality of samples and the label of each of the selected subset of the scored plurality of samples, the augmenting resulting in an augmented dataset of labeled data; and
retraining, using the augmented dataset of labeled data, the model, wherein the retraining comprises further adjusting the feature extractor parameter of the model, the classifier parameter of the model, and the discriminator parameter of the model.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, wherein the discriminator parameter of the model is adjusted using a quantization loss of the model.

13. The computer program product of claim 12, wherein scoring the plurality of samples of a dataset of unlabeled data comprises combining an uncertainty score, a diversity score and a class imbalance score of a sample in the plurality of samples.

14. The computer program product of claim 13, wherein the uncertainty score is computed using a weighted sum, each addend in the weighted sum comprising an upper bound of losses incurred on an unlabeled data point divided by the number of data points belonging to a particular class of data points.

15. The computer program product of claim 13, wherein the diversity score is computed using a number of data points in the first dataset of labeled data, a number of data points in the selected subset of the scored plurality of samples, and the parametric function, the parametric function quantifying how well the first dataset of labeled data represents a combined dataset, the combined dataset comprising the first dataset of labeled data and the dataset of unlabeled data.

16. The computer program product of claim 13, wherein the class imbalance score is computed using a weighted sum, each addend in the weighted sum comprising a result of performing the model divided by the cube root of the number of data points belonging to a particular class of data points.

17. The computer program product of claim 9, further comprising:
subtracting, from a query budget, a number of samples in the selected subset of the scored plurality of samples.

18. The computer program product of claim 17, further comprising:
causing, responsive to determining that the query budget is greater than zero, labeling of the selected subset of the scored plurality of samples.

19. A computer system comprising a processor and one or more computer readable storage media, and program instructions collectively stored on the one or more computer readable storage media, the program instructions executable by the processor to cause the processor to perform operations comprising:
training, using a first dataset of labeled data, a model, wherein the training comprises adjusting a feature extractor parameter of the model, a classifier parameter of the model, and a discriminator parameter of the model;
scoring, using the discriminator parameter and a parametric function of the feature extractor parameter, a plurality of samples of a dataset of unlabeled data, the scoring resulting in a scored plurality of samples;
selecting, for labeling, a subset of the scored plurality of samples, the selecting resulting in a selected subset of the scored plurality of samples;
augmenting, responsive to receiving a label of each of the selected subset of the scored plurality of samples, the first dataset of labeled data with the selected subset of the scored plurality of samples and the label of each of the selected subset of the scored plurality of samples, the augmenting resulting in an augmented dataset of labeled data; and
retraining, using the augmented dataset of labeled data, the model, wherein the retraining comprises further adjusting the feature extractor parameter of the model, the classifier parameter of the model, and the discriminator parameter of the model.

20. The computer system of claim 19, wherein the discriminator parameter of the model is adjusted using a quantization loss of the model.
